(19) United States
(12) Patent Application Publication
(10) Pub. No.: US 2023/0385475 A1
(43) Pub. Date: Nov. 30, 2023

(54) ESTIMATION OF MECHANISTIC CHROMATOGRAPHY MODEL UNCERTAINTY

(71) Applicant: GENENTECH, INC., South San Francisco, CA (US)

(72) Inventors: Jessica Yang LYALL, Los Altos, CA (US); Connor James THOMPSON, San Francisco, CA (US); Sean Mackenzie BURGESS, San Francisco, CA (US)

(73) Assignee: GENENTECH, INC., South San Francisco, CA (US)

(21) Appl. No.: 18/447,986

(22) Filed: Aug. 10, 2023

Related U.S. Application Data
(63) Continuation of application No. PCT/US2022/021843, filed on Mar. 25, 2022.
(60) Provisional application No. 63/166,939, filed on Mar. 26, 2021.

(51) Int. Cl. G06F 30/17; G06F 30/20

(52) U.S. Cl. CPC G06F 30/17; G06F 30/20

(57) ABSTRACT

A method, system, and non-transitory computer readable medium for estimating mechanistic chromatography model uncertainty. A mechanistic model of chromatography that comprises a plurality of parameters is received. For each of the plurality of parameters, a corresponding region of values is identified based on a relationship between values for the plurality of parameters. Each parameter of the plurality of parameters is sampled within the corresponding region of values for each parameter to form a plurality of simulation sets. An uncertainty for the mechanistic model is quantified using the plurality of simulation sets.

### CROSS-REFERENCE TO RELATED APPLICATIONS

The application claims priority to and the benefit of U.S. Provisional Application No. 63/166,939, filed Mar. 26, 2021, the contents of these are incorporated herein in its entirety.

### FIELD OF THE DISCLOSURE

This description is generally directed towards mechanistic chromatography modeling. More specifically, this description provides methods and systems for estimating the uncertainty associated with a mechanistic chromatography model.

### INTRODUCTION

Generally, chromatography is the primary process used to purify biopharmaceutical products. Mechanistic modeling may be used to improve chromatographic processes, investigate issues with respect to these processes, and perform chromatography simulations. A mechanistic model makes the assumption that a complex system or process can be understood by examining how the individual parts of the system or process work and the manner in which those parts are coupled. A mechanistic model then represents this complex system or process mathematically in a simplified manner that still captures the underlying principles of the complex system or process. One barrier to widespread or systematic application of mechanistic models for processes such as chromatographic processes may be the difficulty associated with qualifying and establishing confidence in mechanistic models. For example, some currently available methodologies for estimating mechanistic model uncertainty are more time-consuming and computationally-expensive than desired.

### SUMMARY

In one or more embodiments, a method is provided for estimating mechanistic chromatography model uncertainty. A mechanistic model of chromatography that comprises a plurality of parameters is received. For each of the plurality of parameters, a corresponding region of values is identified based on a relationship between values for the plurality of parameters. Each parameter of the plurality of parameters is sampled within the corresponding region of values for each parameter to form a plurality of simulation sets. An uncertainty for the mechanistic model is quantified using the plurality of simulation sets.

In one or more embodiments, a system for estimating mechanistic chromatography model uncertainty is provided. The system comprises a data source configured to obtain a mechanistic model of chromatography; and a processor configured to receive the mechanistic model of chromatography from the data source in which the mechanistic model includes a plurality of parameters. The processor is further configured to: identify, for each of the plurality of parameters, a corresponding region of values based on a relationship between values for the plurality of parameters; sample each parameter of the plurality of parameters within the corresponding region of values for each parameter to form a plurality of simulation sets; and quantify an uncertainty for the mechanistic model using the plurality of simulation sets.

In one or more embodiments, a non-transitory computer-readable medium is provided in which a program is stored, the program being configured for causing a computer to perform a method for estimating mechanistic chromatography model uncertainty. The method comprises receiving a mechanistic model of chromatography that comprises a plurality of parameters; identifying, for each of the plurality of parameters, a corresponding region of values based on a relationship between values for the plurality of parameters; sampling each parameter of the plurality of parameters within the corresponding region of values for each parameter to form a plurality of simulation sets; and quantify an uncertainty for the mechanistic model using the plurality of simulation sets.

### BRIEF DESCRIPTION OF THE DRAWINGS

For a more complete understanding of the principles disclosed herein, and the advantages thereof, reference is now made to the following descriptions taken in conjunction with the accompanying drawings, in which:

FIG. 1 is a schematic diagram of a chromatography system in accordance with various embodiments.

FIG. 2 is a block diagram of a model analysis system in accordance with various embodiments.

FIG. 3 is a flowchart of a process for estimating mechanistic model uncertainty in accordance with various embodiments.

FIG. 4 is a flowchart of a process for predicting mechanistic chromatography model uncertainty in accordance with various embodiments.

FIG. 5 is a flowchart of a process for computing a covariance matrix for a mechanistic model in accordance with various embodiments.

FIG. 6 is a side-by-side comparison of two different types of multiparametric plots generated for a mechanistic model in accordance with various embodiments.

FIG. 7 is an illustration of a table comparing uncertainty values generated via a Hessian approach and uncertainty values generated using a Markov Chain Monte Carlo approach.

FIG. 8 is a block diagram of a computer system in accordance with various embodiments.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

### I. Overview

Mechanistic modeling is an important tool for understanding how various systems and processes work. Mechanistic chromatography modeling, for example, may be an important tool for a variety of biological, pharmaceutical, and biopharmaceutical applications. Mechanistic chromatography modeling enables non-destructive, real-time measurement of molecule attributes during a simulated chromatographic process (e.g., a simulated chromatographic purification), which can provide meaningful insights into the chromatographic process being simulated.

When validated or otherwise justified, mechanistic chromatography modeling may describe chromatography in a manner that allows confidence in interpolation and extrapolation from the results generated via the mechanistic chromatography modeling. Further, mechanistic chromatography modeling may allow process optimization, real-time process monitoring, control chromatographic processes, and other operations that provide insight into the chromatographic process. Still further, this type of modeling may enable the identification of specific operating parameters that are critical to the chromatographic process.

Being able to use a mechanistic chromatography model with confidence for a given application may require understanding the predictive power of the mechanistic chromatography model. For example, it may be important to understand the precision of the predictions being made via the mechanistic chromatography model. Some currently available methods for evaluating such mechanistic chromatography models evaluate or estimate the uncertainties associated with the individual parameters of the model. But parameter uncertainties may not provide any indication of the predictive power of the overall mechanistic chromatography model. Further, some currently available methodologies for assessing the uncertainty of a mechanistic chromatography model are computationally expensive and time-consuming. For example, one currently available method for assessing the uncertainty of a mechanistic chromatography model may require days of processing resources (e.g., 10⁵ or 10⁶ function calls). Thus, the time, cost, and processing resources required with respect to such methodologies may make using these methodologies practically infeasible for certain applications.

Recognizing and taking into account the importance of having confidence in the mechanistic chromatography models being used for a given application, the various embodiments described herein provide methods and systems for evaluating a mechanistic chromatography model. For example, the various embodiments described herein provide methods and systems for determining how precise a mechanistic chromatography model is based on estimates of the uncertainty associated with the mechanistic chromatography model. The methods and systems described herein enable estimating the uncertainty of a mechanistic chromatography model in a manner that is faster and computationally less expensive than at least some of the currently available methods and systems. For example, without limitation, the various embodiments described herein may enable computing the uncertainty of a mechanistic chromatography model in a matter of hours (e.g., less than six hours in some cases) as compared to the several days needed by some currently available methods. In one or more embodiments, these time savings may be at least in part due to a fewer number of function calls (e.g., 10³ to 10⁴ function calls) being used as compared to the 105 or 106 function calls needed by some currently available methods. Thus, savings with respect to time, cost, and processing resources may be achieved.

### II. Definitions

The disclosure is not limited to these exemplary embodiments and applications or to the manner in which the exemplary embodiments and applications operate or are described herein. Moreover, the figures may show simplified or partial views, and the dimensions of elements in the figures may be exaggerated or otherwise not in proportion.

In addition, as the terms “on,” “attached to,” “connected to,” “coupled to,” or similar words are used herein, one element (e.g., a component, a material, a layer, a substrate, etc.) can be “on,” “attached to,” “connected to,” or “coupled to” another element regardless of whether the one element is directly on, attached to, connected to, or coupled to the other element or there are one or more intervening elements between the one element and the other element. In addition, where reference is made to a list of elements (e.g., elements a, b, c), such reference is intended to include any one of the listed elements by itself, any combination of less than all of the listed elements, and/or a combination of all of the listed elements. Section divisions in the specification are for ease of review only and do not limit any combination of elements discussed.

Unless otherwise defined, scientific and technical terms used in connection with the present teachings described herein shall have the meanings that are commonly understood by those of ordinary skill in the art. Further, unless otherwise required by context, singular terms shall include pluralities and plural terms shall include the singular. Generally, nomenclatures utilized in connection with, and techniques of, chemistry, biochemistry, molecular biology, pharmacology and toxicology are described herein are those well-known and commonly used in the art.

As used herein, “substantially” means sufficient to work for the intended purpose. The term “substantially” thus allows for minor, insignificant variations from an absolute or perfect state, dimension, measurement, result, or the like such as would be expected by a person of ordinary skill in the field but that do not appreciably affect overall performance. When used with respect to numerical values or parameters or characteristics that can be expressed as numerical values, “substantially” means within ten percent.

The term “ones” means more than one.

As used herein, the term “plurality” can be 2, 3, 4, 5, 6, 7, 8, 9, 10, or more.

As used herein, the term “set of” means one or more. For example, a set of items includes one or more items.

As used herein, the phrase “at least one of,” when used with a list of items, means different combinations of one or more of the listed items may be used and only one of the items in the list may be needed. The item may be a particular object, thing, step, operation, process, or category. In other words, “at least one of” means any combination of items or number of items may be used from the list, but not all of the items in the list may be required. For example, without limitation, “at least one of item A, item B, or item C” means item A; item A and item B; item B; item A, item B, and item C; item B and item C; or item A and C. In some cases, “at least one of item A, item B, or item C” means, but is not limited to, two of item A, one of item B, and ten of item C; four of item B and seven of item C; or some other suitable combination.

As used herein, a “model” may include one or more algorithms, one or more mathematical techniques, one or more machine learning algorithms, or a combination thereof.

As used herein, an “analyte” refers to a mixture comprising one or more individual components. In the context of chromatography, an analyte may be a mixture whose individual components or molecules are to be separated and analyzed.

As used herein, “chromatography” refers to a technique or process for separating an analyte into various components (e.g., molecules) of interest. An analyte is typically dissolved in a fluid (e.g., gas, solvent, water, etc.), which is generally referred to as the “mobile phase” or the carrier. The mobile phase carries the solute through a system (e.g., a column, a capillary tube, a plate, sheet, etc.) on or in which is fixed a material generally referred to as the stationary phase or the adsorbent. The stationary phase may include, for example, but is not limited to, silica gel beads, or some other type of particle that can be fixed and packed. The different molecules of the analyte may have different affinities for the stationary phase and may have different interactions with the stationary phase that can be analyzed. Further, chromatography involves various fluid dynamics principles including, for example, convection, dispersion, diffusion, and adsorption. Diffusion includes, for example, film diffusion and pore diffusion.

As used herein, “convection” refers to the mechanism of mass transfer due to the bulk motion of a fluid. The movement of this fluid is induced by an external force. With respect to chromatography, convection means the movement of an analyte within the mobile phase towards the stationary phase as the analyte is transported through the column by the movement of the mobile phase. The movement of the mobile phase is driven by an external force such as a pressure gradient, while the movement of the analyte towards the stationary phase is driven by a concentration gradient.

As used herein, “dispersion” refers to the mechanism of mass transfer due to non-ideal fluid flow patterns resulting in the spreading of mass from high concentration to low concentration areas. In chromatography, the packing in a column consists of particles (e.g., beads) with flow channels formed in between these particles. Differences in packing and particle shape may cause differences in the speed of the mobile phase in the different flow channels. Further, the analyte molecules flowing within the mobile phase may travel at different speeds along the different flow channels. The difference in velocities as well as other flow disturbances result in the spreading of mass in the axial direction.

As used herein, “diffusion” refers to the mechanism of mass transfer from high concentration to low concentration areas due to the random motion of particles (Brownian motion) in a fluid. This motion is a microscopic effect independent of fluid flow and is driven by a concentration gradient within the fluid. A chromatography column may be packed with particles (or beads) that are porous. In chromatography, the mobile phase enters the pores in these beads and the stagnant layer of the mobile phase (fluid) creates a “film” around the bead. Diffusion in the mobile phase is described by convection. Film diffusion occurs when a molecule passes through the bead's film into, for example, a pore. Pore diffusion is the movement of the molecule within the pore.

As used herein, “adsorption” refers to the process by which the analyte that is present in the stationary phase pore adheres to the inner surface of the bead. The adsorption may be driven by various mechanisms depending on the properties of the molecule and the stationary phase, such as, for example, but not limited to, charge, hydrophobicity, and polarity.

As used herein, a “mechanistic model” refers to a model that is based on the fundamental laws of natural sciences. Physical and biochemical principles constitute the model equations that make up the mechanistic model. For example, a mechanistic model may be comprised of mathematical equations that represent a complex system or process, its individual parts, and how those parts are coupled or used together. A mechanistic model may need few experimental data or data points to calibrate the model and determine unknown model parameters. For example, in some cases, the parameters for a mechanistic model can be determined in between about three to ten experiments. Generally, the parameters of a mechanistic model have an actual physical meaning, which can help facilitate interpretation of predictions made by the mechanistic model. Further, because the parameters have actual physical meanings, mechanistic models allow one to easily change parameters to model different processes. Thus, a single mechanistic model may be used to capture a wide variety of model applications and, in some cases, ensure quality obligations via design.

As used herein, a “mechanistic chromatography model” is a mechanistic model that is used to represent a chromatographic process. A mechanistic chromatography model may include various parameters, such as, but not limited to, adsorption coefficients, diffusivity properties, material properties, other types of properties, or a combination thereof. Relying on the laws of natural science, a mechanistic chromatography model represents the different effects involved in chromatography including, for example, fluid dynamics, mass transfer phenomena, and thermodynamics of phase equilibria. For example, a mechanistic chromatography model may take into account convection, dispersion, diffusion (film diffusion and pore diffusion), adsorption, or a combination thereof. Generally, a mechanistic chromatography model includes many process parameters directly in the model equations. Further, many various process quality attributes can be calculated from the simulation results generated from the mechanistic chromatography model. In this manner, a mechanistic chromatography model may be used to examine or analyze the effects on the chromatographic process in silico.

### III. Mechanistic Chromatography Modeling

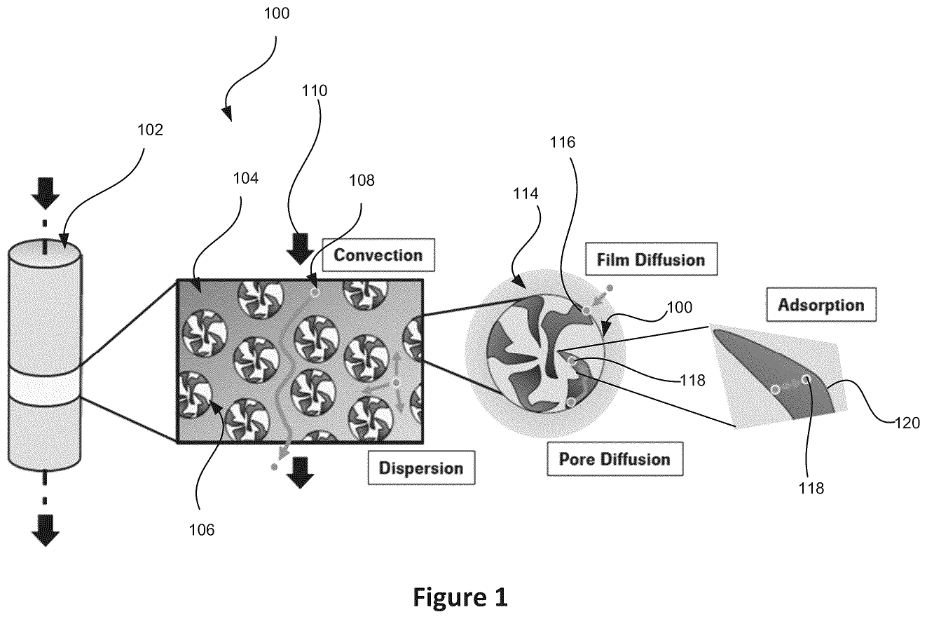

FIG. 1 is a schematic diagram of a chromatography system 100 in accordance with various embodiments. Chromatography system 100 includes column 102, which is one example of a type of column or system that may be used in chromatography system 100. Column 102 is filled with fluid 104 in which particles 106 (e.g., beads, silica gel beads) have been packed to form a packed bed.

Molecules 108 that are of interest may be injected in column 102. In various embodiments, molecules 108 take the form of proteins. In various embodiments, chromatography system 100 may be used to perform protein purification. In one or more embodiments, molecules 108 include antibodies, antibody fragments, antibody complexes, nucleic acids, and/or other types of molecules.

After being injected into column 102, molecules 108 are transported via convection within fluid 104 in column 102 in the direction of arrow 110. This flow may be induced via, for example, without limitation, using pressure, force, or both. In one or more embodiments, a pump is connected to column 102 to facilitate convection. Pumping with a higher velocity may lead to greater convection within column 102.

Within chromatography system 100, molecules 108 move within the interstitial spaces formed between particles 106 via the principles of dispersion. These interstitial spaces are flow channels or paths created between particles 106. Various factors may influence the interstitial velocity of molecules 108 within column 102.

Various ones of molecules 108 may pass through the film of various ones of particles 106 via film diffusion to enter the pores of these particles. For example, molecule 112 passes through film 114 of particle 116. The movement of these different molecules within the pores is dominated by pore diffusion. For example, the movement of molecule 118 within pore 120 of particle 116 is dominated by pore diffusion. Further, a molecule, such as molecule 118, may adhere to inner surface 122 of particle 116 via adsorption.

### IV. Prediction of Mechanistic Modeling Uncertainty

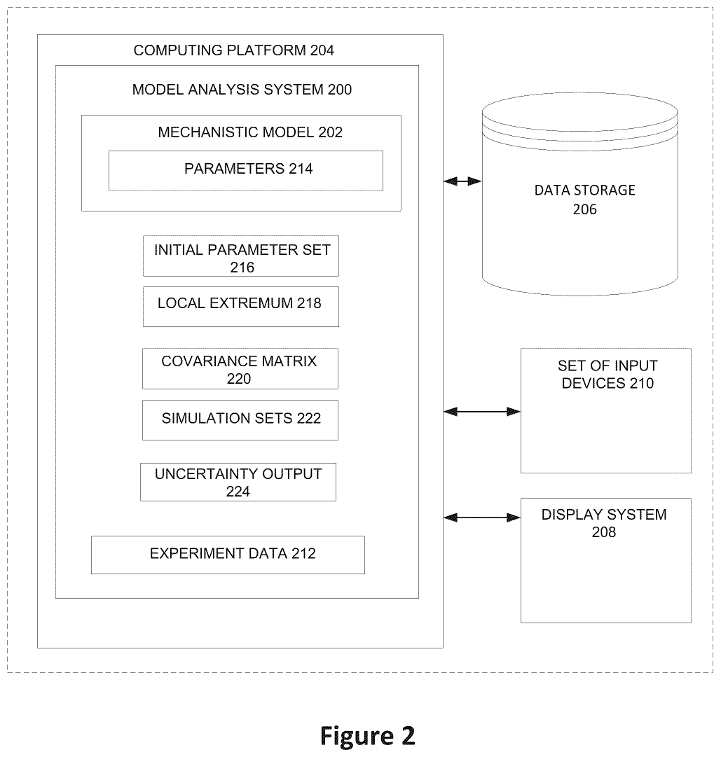

FIG. 2 is a block diagram of a model analysis system 200 in accordance with various embodiments. Model analysis system 200 is used to analyze and provide information about mechanistic model 202. Mechanistic model 202 is a mechanistic chromatography model, which may be also referred to as a mechanistic model of chromatography. In one or more embodiments, mechanistic model 202 is used to study, analyze, simulate, control, modify, or otherwise evaluate a chromatographic system or process, such as, but not limited to, chromatography system 100 in FIG. 1.

In various embodiments, model analysis system 200 may be implemented using hardware, software, firmware, or a combination thereof. In various embodiments, model analysis system 200 may be implemented using computing platform 204. Computing platform 204 may take various forms. In one or more embodiments, computing platform 204 includes a single computer (or computer system) or multiple computers in communication with each other. In other examples, computing platform 204 takes the form of a cloud computing platform.

In one or more embodiments, computing platform 204 may be communicatively coupled with data storage 206, display system 208, set of input devices 210, or a combination thereof. In various embodiments, data storage 206, display system 208, set of input devices 210, or a combination thereof may be considered part of or otherwise integrated with computing platform 204. Thus, in some examples, computing platform 204, data storage 206, and display system 208 may be separate components in communication with each other, but in other examples, some combination of these components may be integrated together.

Model analysis system 200 is used to analyze mechanistic model 202. In one or more embodiments, model analysis system 200 receives mechanistic model 202 for processing. For example, without limitation, model analysis system 200 may receive mechanistic model 202 from a remote source (e.g., another computing platform). In one or more embodiments, model analysis system 200 receives mechanistic model 202 over one or more wired communications links, one or more wireless communications links, one or more optical communications links, or a combination thereof. In various embodiments, mechanistic model 202 is retrieved from data storage 206.

In various embodiments, model analysis system 200 is used to generate mechanistic model 202 based on experiment data 212. Experiment data 212 may include, for example, data obtained or generated by performing one, two, three, or some other number of experiments. In one or more embodiments, experiment data 212 is generated using the data from about three to about ten experiments. In one or more embodiments, experiment data 212 is stored in data storage 206.

Mechanistic model 202 includes a plurality of parameters 214. In various embodiments, at least a portion of parameters 214 may have actual physical meanings. In one or more embodiments, each of plurality of parameters 214 has an actual physical meaning that corresponds to the process of chromatography, fluid dynamics, mass transfer phenomena, or other properties or factors. In this manner, each of parameters 214 may provide a way of relating the output of mechanistic model 202 with the actual process of chromatography.

Model analysis system 200 first identifies initial parameter set 216. In one or more embodiments, initial parameter set 216 is a randomly or near-randomly selected set of values for parameters 214. In various embodiments, initial parameter set 216 is the result of a previous round of parameter set processing. Initial parameter set 216 may also be referred to as initial parameter values. In one or more embodiments, model analysis system 200 uses Latin hypercube sampling (LHS) (also referred to as a Latin hypercube screen) to randomly or near-randomly select initial parameter set 216. In various embodiments, a loss function or minimization algorithm is used to identify initial parameter set 216.

Model analysis system 200 finds a local extremum 218 for mechanistic model 202 using a selected loss function. In one or more embodiments, the selected loss function takes the form of a maximum log-likelihood function, a negative log-likelihood function, or a maximum likelihood function. An optimization algorithm may be selected to identify local extremum 218 for the selected loss function. The selected loss function is selected to generally ensure that a local extremum can be reached given initial parameter set 216. The optimization algorithm may include any number of or combination of algorithms. In one or more embodiments, the optimization algorithm may include a Levenberg-Marquardt (LM) minimization algorithm. In various embodiments, the optimization algorithm may include Gradient descent, Gauss-Newton, Broden-Fletcher-Goldfarb-Shanno (BFGS), or another gradient-based non-heuristic optimization algorithm.

Model analysis system 200 makes an assumption about the relationship between parameters 214. In various embodiments, model analysis system 200 makes an assumption that the underlying distribution is a multiparametric (multivariate) Gaussian distribution. This assumption is made to provide savings with respect to time, cost, processing resources, or a combination thereof. With this assumption, the range of values that is to be sampled from each of parameters 214 can be narrowed to improve the chances of sampling being performed for each of parameters 214 where the parameters, when looked at simultaneously, are most correlated. In other words, sampling is performed from the more likely values of parameters 214 based on the multiparametric (multivariate) Gaussian distribution.

Based on this assumption, covariance matrix 220 may be computed at local extremum 218. Covariance matrix 220 describes a multiparametric (multivariate) Gaussian distribution across parameters 214 and helps identify the “narrowed space” from which parameters 214 may be sampled in order to reliably determine the uncertainty of mechanistic model 202.

Model analysis system 200 samples each of parameters 214 to form a plurality of simulation sets 222. Model analysis system 200 runs simulations of mechanistic model 202 using simulation sets 222 to generate various predictions using mechanistic model 202. These predictions are used to quantify an uncertainty for mechanistic model 202. For example, in one or more embodiments, the predictions are used to generate an uncertainty output 224 for mechanistic model 202. Uncertainty output 224 may include, for example, without limitation, an indication of the precision of mechanistic model 202. In one or more embodiments, uncertainty output 224 identifies a confidence interval or one or more confidence values for mechanistic model 202. For example, uncertainty output 224 may identify values for 95% confidence, 99.7% confidence, some other level of confidence, or a combination thereof. By providing information about the precision associated with mechanistic model 202, model analysis system 200 can provide confidence in mechanistic model 202.

Uncertainty output 224 may take various forms. For example, uncertainty output 224 may be one or more values, a report containing a confidence interval, an alert identifying a confidence interval, a plot, some other type of visual representation of uncertainty, or a combination thereof. In one or more embodiments, model analysis system 200 displays uncertainty output 224 on display system 208. In various embodiments, model analysis system 200 displays an output generated based on uncertainty output 224 on display system. For example, uncertainty output 224 may include one or more confidence values (e.g., a 95% confidence value, a 5% and 95% confidence value, etc.). Model analysis system 200 may display an alert or a report on display system 208 that indicates whether these confidence values are acceptable (e.g., above or below a selected threshold).

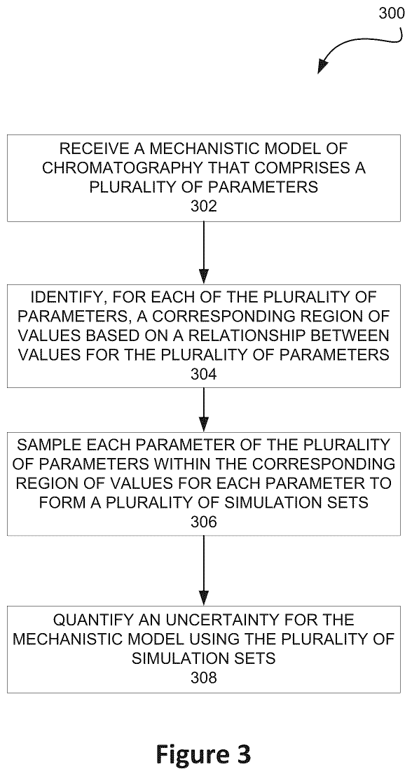

FIG. 3 is a flowchart of a process 300 for estimating mechanistic model uncertainty in accordance with various embodiments. In various embodiments, process 300 is implemented using the model analysis system 200 described in FIG. 2. In particular, process 300 may be used to generate an uncertainty output that provides an indication of the uncertainty associated with predictions from a mechanistic chromatography model such as, for example, without limitation, mechanistic model 202 in FIG. 2.

Step 302 includes receiving a mechanistic model of chromatography that comprises a plurality of parameters. The mechanistic model may include a plurality of parameters. In one or more embodiments, each of these parameters may have an actual physical meaning. In various embodiments, a single mechanistic model can be employed for a wide variety of applications.

Step 304 includes identifying, for each of the plurality of parameters, a corresponding region of values based on a relationship between values for the plurality of parameters. In one or more embodiments, step 304 includes assuming that the distributions for the parameters are Gaussian or near-Gaussian. For example, step 304 may include assuming that the distribution of each parameter of the mechanistic model is or is similar to a Gaussian distribution. Thus, across the parameters, in one or more embodiments, the mechanistic model may have a multiparametric (multivariate) Gaussian distribution. In one or more embodiments, step 304 includes identifying a peak of the distribution for each parameter and a range of values for that parameter centered around or otherwise around the peak.

Identifying the corresponding region of values based on the relationship between the parameters results in looking at the parameters simultaneously to get a more complete and thorough picture of the parameters and where the most likely values of parameters are expected to be. Further, time that would otherwise be spent on analyzing values for parameters that are less likely can be avoided. The corresponding region of values that is identified provides a framework from which a new sampling space can be used to determine model uncertainty.

Step 306 includes sampling each parameter of the plurality of parameters within the corresponding region of values for each parameter to form a plurality of simulation sets. Step 306 includes generating, for example, without limitation, N simulation sets. Each simulation set includes a sample value for each of the parameters of the mechanistic model. Sampling each parameter from within the corresponding region of values as opposed to the entire available space for each parameter can save time, cost, and processing resources.

Step 308 includes quantifying an uncertainty for the mechanistic model using the plurality of simulation sets. In various embodiments, step 308 includes generating an uncertainty output for the mechanistic model, identifying a confidence interval for the mechanistic model, or a combination thereof. The sampling performed in step 306 occurs in a precise manner that helps ensure that the quantification of the uncertainty performed in step 308 is a reliable measure for the precision of the mechanistic model's predictions.

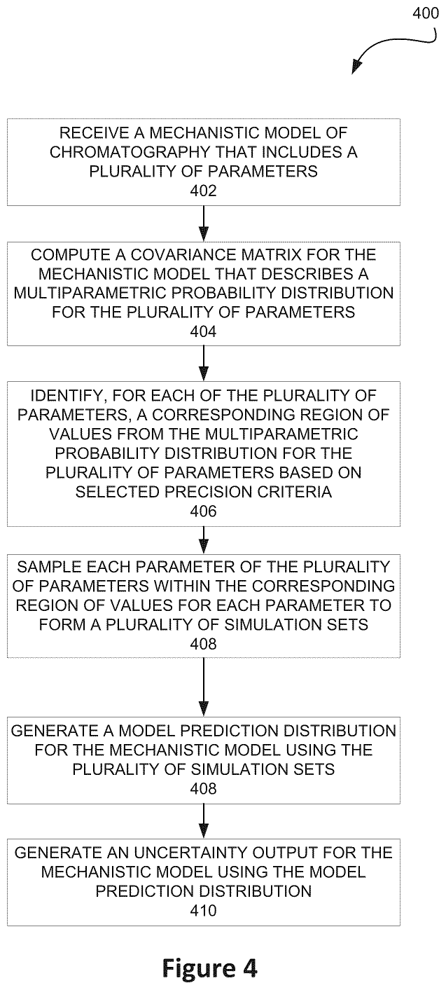

FIG. 4 is a flowchart of a process 400 for predicting mechanistic chromatography model uncertainty in accordance with various embodiments. In various embodiments, process 400 is implemented using the model analysis system 200 described in FIG. 2. In particular, process 400 may be used to predict the uncertainty of a mechanistic chromatography model such as, for example, without limitation, mechanistic model 202 in FIG. 2.

Step 402 includes receiving a mechanistic model of chromatography that includes a plurality of parameters. In one or more embodiments, the mechanistic model is a model generated from fewer than 20 experiments.

Step 404 includes computing a covariance matrix for the mechanistic model that describes a multiparametric probability distribution for the plurality of parameters. In one or more embodiments, the multiparametric probability distribution takes the form of a multiparametric (multivariate) multiparametric Gaussian distribution.

Step 406 includes identifying, for each of the plurality of parameters, a corresponding region of values from the multiparametric probability distribution of the plurality of parameters based on selected precision criteria to form a plurality of simulation sets. The selected precision criteria may include various criteria for narrowing the range of values to be sampled for a given parameter. In one or more embodiments, the selected precision criteria include, for each parameter of the plurality of parameters, a range of values that meets a threshold likelihood of occurrence.

Step 408 includes sampling each parameter of the plurality of parameters within the corresponding region of values for each parameter to form a plurality of simulation sets.

Step 410 includes generating a model prediction distribution for the mechanistic model using the plurality of simulation sets. This model prediction distribution captures the various predictions generated by the mechanistic model based on the simulation sets.

Step 412 includes generating an uncertainty output for the mechanistic model using the model prediction distribution. The uncertainty output generated in step 410 provides an indication of how precise the predictions of the mechanistic model are. The uncertainty output may include, for example, without limitation, a confidence interval for the mechanistic model (e.g., a 95% confidence interval, a 99.7% confidence interval, etc.), some other representation of uncertainty in the mechanistic model, an alert that includes the confidence interval, a report that includes the confidence interval, some other type of output, or a combination thereof.

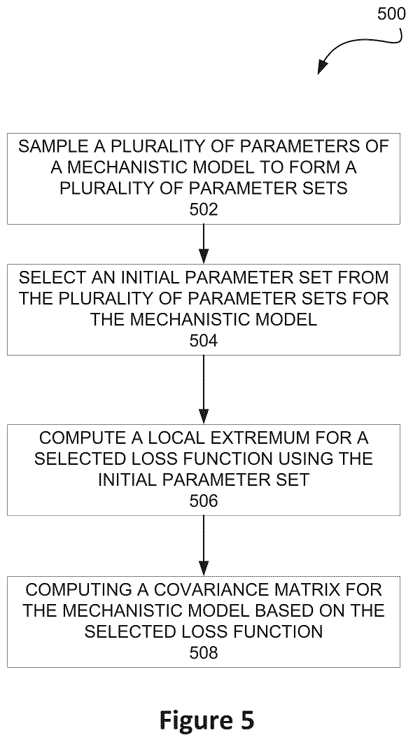

FIG. 5 is a flowchart of a process 500 for computing a covariance matrix for a mechanistic model in accordance with various embodiments. Process 500 in FIG. 5 may be one example of a process that is used to compute a covariance matrix for a mechanistic model and may include one or more steps that can be used to implement step 404 in FIG. 4.

Step 502 sampling a plurality of parameters of a mechanistic model to form a plurality of parameter sets. In one or more embodiments, step 502 includes running a near-random sampling process (or random parameter screen) to find an initial parameter set for processing. In one or more embodiments, Latin hypercube sampling may be used to implement the near-random sampling process.

Step 504 includes selecting an initial parameter set from the plurality of parameter sets for the mechanistic model. For example, in step 504, the best-fitting parameter set may be used as the initial parameter set. In one or more embodiments, step 504 may be referred to as global optimization step and may be performed using, for example, any of a number of different types of loss functions. Examples of loss functions that can be used include, but are not limited to, a root-mean-square error (RMSE) algorithm, a maximum log-likelihood (or log-likelihood) algorithm, a negative log-likelihood algorithm, or a maximum likelihood algorithm. The initial parameter set formed in step 504 is the parameter set from which further optimization can be performed. In one or more embodiments, step 504 includes identifying the search area from which a local extremum is to be identified.

Step 506 includes computing a local extremum for a selected loss function using the initial parameter set. In one or more embodiments, the selected loss function is a maximum log-likelihood (or log-likelihood), a negative log-likelihood, or a maximum likelihood algorithm. Thus, in some cases, the selected loss function used in step 506 may be the same or different from the loss function used in step 504. When the selected loss function is negative log-likelihood, the local extremum computed is the local minimum. When the selected loss function is maximum log-likelihood (or log-likelihood), the local extremum computed is the local maximum. When the selected loss function is maximum likelihood, the local extremum computed is the local maximum. In one or more embodiments, one or more different types of optimization algorithms may be used to identify the local extremum. For example, a minimization algorithm such as the Levenberg-Marquardt (LM) minimization algorithm may be used to identify the desired local extremum for the selected loss function.

Step 508 includes computing a covariance matrix for the mechanistic model based on the selected loss function. The covariance matrix describes the underlying multiparametric (multivariate) Gaussian distribution of the plurality of parameters.

When the selected loss function is negative log-likelihood, a Hessian matrix of the selected loss function is computed at the local minimum and inverted to obtain the covariance matrix. When the selected loss function is maximum log-likelihood (or log-likelihood), the Hessian matrix of the selected loss function is computed at the local maximum and the inverted negative of this Hessian matrix is used to get the covariance matrix. When the selected loss function is maximum likelihood, the Hessian matrix is computed for the log of the selected loss function at the local maximum and the inverted negative of this Hessian matrix is used to get the covariance matrix.

### V. Examples/Results

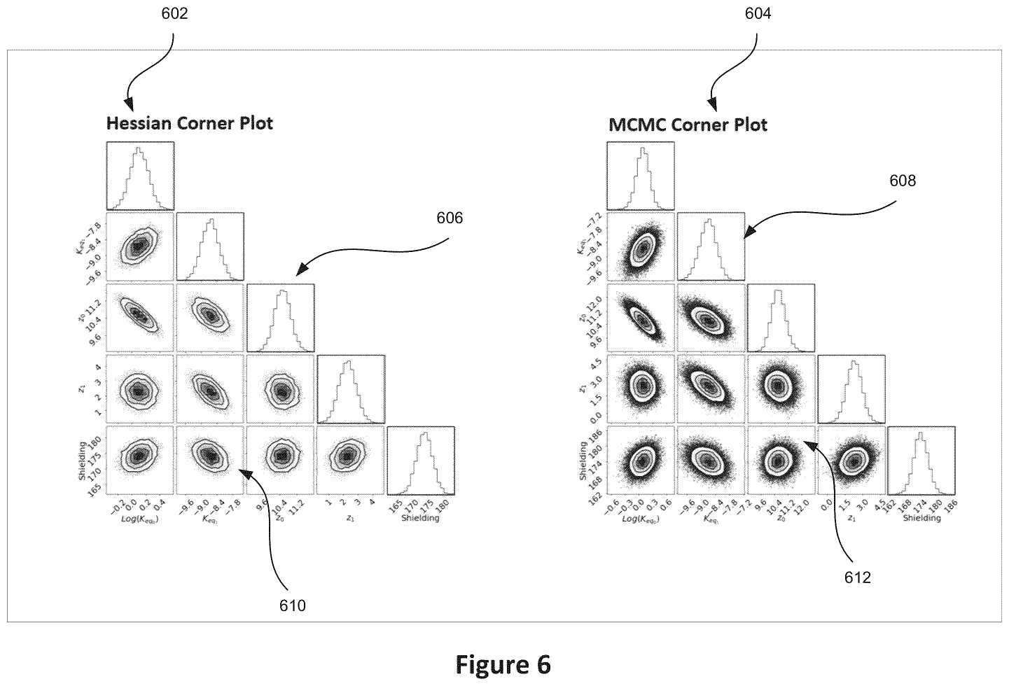

FIG. 6 is a side-by-side comparison of two different types of multiparametric plots generated for a mechanistic model in accordance with various embodiments. In FIG. 6, first multiparametric plot 602 is generated using a Hessian approach. Second multiparametric plot 604 is generated using a Markov Chain Monte Carlo (MCMC) approach. First multiparametric plot 602 and second multiparametric plot 604 identify distributions 606 and distributions 608, respectively, for the parameters of the mechanistic model. Further, first multiparametric plot 602 and second multiparametric plot 604 identify covariances 610 and covariances 612, respectively, between the parameters of the mechanistic model.

As shown in FIG. 6, the plots of both approaches appear similar. More particularly, distributions 606 of first multiparametric plot 602 and distributions 608 of second multiparametric plot 604 appear similar. Further, correlations 610 of first multiparametric plot 602 and correlations 612 of second multiparametric plot 604 appear similar. These similarities reinforce the idea that the Hessian approach may be used for sampling to estimate the uncertainty of the predictions made using the mechanistic model. Further, the Hessian approach may provide savings with respect to time, cost, and processing resources. For example, second multiparametric plot 604 appears denser than first multiparametric plot 602 because it requires more samples and data points, which requires more time and processing resources.

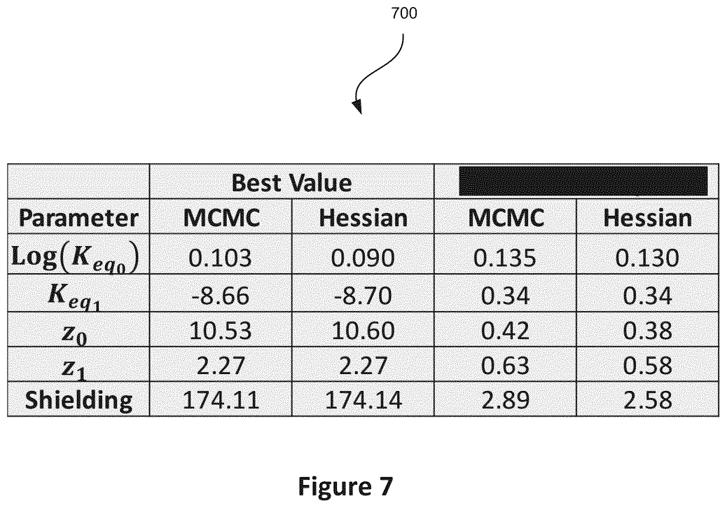

FIG. 7 is an illustration of a table 700 comparing uncertainty values generated via the Hessian approach and uncertainty values generated using the MCMC approach. The best values and 95% confidence values shown in table 700 indicate that the Hessian approach and the MCMC approach generate similar data. Accordingly, the Hessian approach may be used in various applications to reduce the time, cost, and processing resources associated with determining mechanistic model uncertainty and, in particular, mechanistic chromatography model uncertainty.

### VI. Computer Implemented System

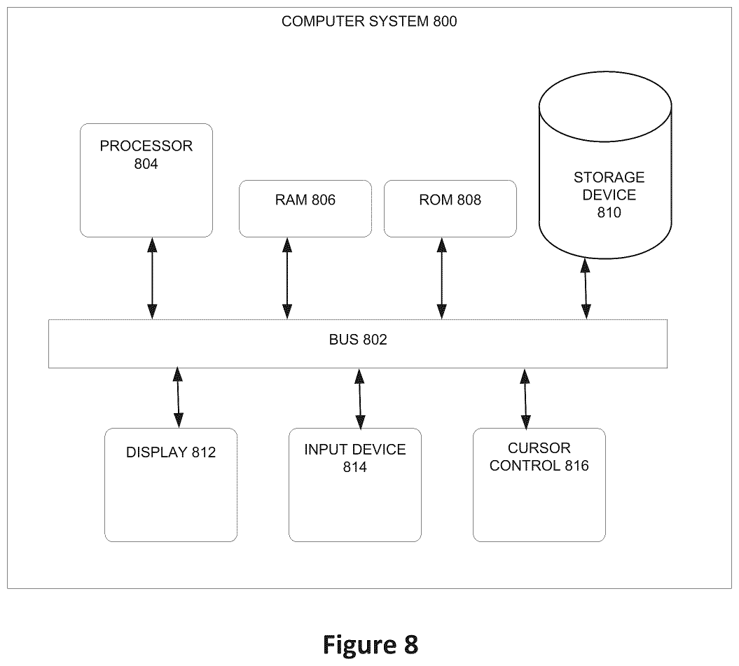

FIG. 8 is a block diagram of a computer system in accordance with various embodiments. Computer system 800 may be an example of one implementation for computing platform 204 described above in FIG. 2. In one or more examples, computer system 800 can include a bus 802 or other communication mechanism for communicating information, and a processor 804 coupled with bus 802 for processing information. In various embodiments, computer system 800 can also include a memory, which can be a random-access memory (RAM) 806 or other dynamic storage device, coupled to bus 802 for determining instructions to be executed by processor 804. Memory also can be used for storing temporary variables or other intermediate information during execution of instructions to be executed by processor 804. In various embodiments, computer system 800 can further include a read only memory (ROM) 808 or other static storage device coupled to bus 802 for storing static information and instructions for processor 804. A storage device 810, such as a magnetic disk or optical disk, can be provided and coupled to bus 802 for storing information and instructions.

In various embodiments, computer system 800 can be coupled via bus 802 to a display 812, such as a cathode ray tube (CRT) or liquid crystal display (LCD), for displaying information to a computer user. An input device 814, including alphanumeric and other keys, can be coupled to bus 802 for communicating information and command selections to processor 804. Another type of user input device is a cursor control 816, such as a mouse, a joystick, a trackball, a gesture input device, a gaze-based input device, or cursor direction keys for communicating direction information and command selections to processor 804 and for controlling cursor movement on display 812. This input device 814 typically has two degrees of freedom in two axes, a first axis (e.g., x) and a second axis (e.g., y), that allows the device to specify positions in a plane. However, it should be understood that input devices 814 allowing for three-dimensional (e.g., x, y and z) cursor movement are also contemplated herein.

Consistent with certain implementations of the present teachings, results can be provided by computer system 800 in response to processor 804 executing one or more sequences of one or more instructions contained in RAM 806. Such instructions can be read into RAM 806 from another computer-readable medium or computer-readable storage medium, such as storage device 810. Execution of the sequences of instructions contained in RAM 806 can cause processor 804 to perform the processes described herein. Alternatively, hard-wired circuitry can be used in place of or in combination with software instructions to implement the present teachings. Thus, implementations of the present teachings are not limited to any specific combination of hardware circuitry and software.

The term “computer-readable medium” (e.g., data store, data storage, storage device, data storage device, etc.) or “computer-readable storage medium” as used herein refers to any media that participates in providing instructions to processor 804 for execution. Such a medium can take many forms, including but not limited to, non-volatile media, volatile media, and transmission media. Examples of non-volatile media can include, but are not limited to, optical, solid state, magnetic disks, such as storage device 810. Examples of volatile media can include, but are not limited to, dynamic memory, such as RAM 806. Examples of transmission media can include, but are not limited to, coaxial cables, copper wire, and fiber optics, including the wires that comprise bus 802.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, or any other tangible medium from which a computer can read.

In addition to computer readable medium, instructions or data can be provided as signals on transmission media included in a communications apparatus or system to provide sequences of one or more instructions to processor 804 of computer system 800 for execution. For example, a communication apparatus may include a transceiver having signals indicative of instructions and data. The instructions and data are configured to cause one or more processors to implement the functions outlined in the disclosure herein. Representative examples of data communications transmission connections can include, but are not limited to, telephone modem connections, wide area networks (WAN), local area networks (LAN), infrared data connections, NFC connections, optical communications connections, etc.

It should be appreciated that the methodologies described herein, flow charts, diagrams, and accompanying disclosure can be implemented using computer system 800 as a standalone device or on a distributed network of shared computer processing resources such as a cloud computing network.

The methodologies described herein may be implemented by various means depending upon the application. For example, these methodologies may be implemented in hardware, firmware, software, or any combination thereof. For a hardware implementation, the processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, electronic devices, other electronic units designed to perform the functions described herein, or a combination thereof.

In various embodiments, the methods of the present teachings may be implemented as firmware and/or a software program and applications written in conventional programming languages such as C, C++, Python, etc. If implemented as firmware and/or software, the embodiments described herein can be implemented on a non-transitory computer-readable medium in which a program is stored for causing a computer to perform the methods described above. It should be understood that the various engines described herein can be provided on a computer system, such as computer system 800, whereby processor 804 would execute the analyses and determinations provided by these engines, subject to instructions provided by any one of, or a combination of, the memory components RAM 806, ROM, 808, or storage device 810 and user input provided via input device 814.

While the present teachings are described in conjunction with various embodiments, it is not intended that the present teachings be limited to such various embodiments. On the contrary, the present teachings encompass various alternatives, modifications, and equivalents, as will be appreciated by those of skill in the art.

In describing the various embodiments, the specification may have presented a method and/or process as a particular sequence of steps. However, to the extent that the method or process does not rely on the particular order of steps set forth herein, the method or process should not be limited to the particular sequence of steps described, and one skilled in the art can readily appreciate that the sequences may be varied and still remain within the spirit and scope of the various embodiments.

### Recitation of Embodiments

Embodiment 1. A method for estimating mechanistic chromatography model uncertainty, the method comprising receiving a mechanistic model of chromatography that comprises a plurality of parameters; identifying, for each of the plurality of parameters, a corresponding region of values based on a relationship between values for the plurality of parameters; sampling each parameter of the plurality of parameters within the corresponding region of values for each parameter to form a plurality of simulation sets; and quantifying an uncertainty for the mechanistic model using the plurality of simulation sets.

Embodiment 2. The method of Embodiment 1, wherein identifying, for each of the plurality of parameters, the corresponding region of values comprises computing a covariance matrix for the mechanistic model based on a selected loss function.

Embodiment 3. The method of Embodiment 2, wherein the selected loss function comprises at least one of a negative log-likelihood algorithm, a maximum log-likelihood algorithm, or a maximum likelihood algorithm.

Embodiment 4. The method of Embodiment 2, wherein computing the covariance matrix for the mechanistic model based on the selected loss function comprises identifying a search area using at least one of the selected loss function or another loss function; and computing a local extremum for the selected loss function with respect to the search area.

Embodiment 5. The method of Embodiment 4, wherein computing the covariance matrix for the mechanistic model based on the selected loss function further comprises computing the covariance matrix for the local extremum.

Embodiment 6. The method of any one of Embodiments 1 to 5, wherein identifying, for each of the plurality of parameters, the corresponding region of values comprises sampling the plurality of parameters to form a plurality of parameter sets; selecting an initial parameter set from the plurality of parameter sets for the mechanistic model; and computing a covariance matrix for the mechanistic model based on a selected loss function that uses the initial parameter set.

Embodiment 7. The method of any one of Embodiments 1 to 6, wherein quantifying the uncertainty comprises generating a model prediction distribution for the mechanistic model using the plurality of simulation sets.

Embodiment 8. The method of Embodiment 7, wherein quantifying the uncertainty further comprises identifying a confidence interval for the mechanistic model using the model prediction distribution.

Embodiment 9. The method of any one of Embodiments 1 to 8, further comprising receiving experiment data; and generating the mechanistic model using the experiment data.

Embodiment 10. A system for estimating mechanistic chromatography model uncertainty, the system comprising a data source configured to obtain a mechanistic model of chromatography; and a processor configured to receive the mechanistic model of chromatography from the data source in which the mechanistic model includes a plurality of parameters, and wherein the processor is further configured to identify, for each of the plurality of parameters, a corresponding region of values based on a relationship between values for the plurality of parameters; sample each parameter of the plurality of parameters within the corresponding region of values for each parameter to form a plurality of simulation sets; and quantifying an uncertainty for the mechanistic model using the plurality of simulation sets.

Embodiment 11. The system of Embodiment 10, wherein the processor is further configured to compute a covariance matrix for the mechanistic model based on a selected loss function.

Embodiment 12. The system of Embodiment 11, wherein the selected loss function comprises at least one of a negative log-likelihood algorithm, a maximum log-likelihood algorithm, or a maximum likelihood algorithm.

Embodiment 13. The system of any one of Embodiments 10 to 12, wherein the processor is further configured to identify a search area using at least one of the selected loss function or another loss function and compute a local extremum for the selected loss function with respect to the search area.

Embodiment 14. The system of Embodiment 13, wherein the processor is further configured to compute the covariance matrix for the mechanistic model based on the selected loss function by computing the covariance matrix for the local extremum.

Embodiment 15. The system of any one of Embodiments 10 to 14, wherein the processor is further configured to sample the plurality of parameters to form a plurality of parameter sets, select an initial parameter set from the plurality of parameter sets for the mechanistic model, and compute a covariance matrix for the mechanistic model based on a selected loss function that uses the initial parameter set.

Embodiment 16. The system of Embodiment 15, wherein the processor is further configured to generate a model prediction distribution for the mechanistic model using the plurality of simulation sets and identify a confidence interval for the mechanistic model using the model prediction distribution.

Embodiment 17. The system of any one of Embodiments 10 to 16, wherein the processor is further configured to receive experiment data; and generate the mechanistic model using the experiment data.

Embodiment 18. A non-transitory computer-readable medium in which a program is stored, the program being configured for causing a computer to perform a method for estimating mechanistic chromatography model uncertainty, the method comprising receiving a mechanistic model of chromatography that comprises a plurality of parameters; identifying, for each of the plurality of parameters, a corresponding region of values based on a relationship between values for the plurality of parameters; sampling each parameter of the plurality of parameters within the corresponding region of values for each parameter to form a plurality of simulation sets; and quantifying an uncertainty for the mechanistic model using the plurality of simulation sets.

Embodiment 19. The non-transitory computer-readable medium of Embodiment 18, wherein the method further comprises computing a covariance matrix for the mechanistic model based on a selected loss function.

Embodiment 20. The non-transitory computer-readable medium of Embodiment 19, wherein the selected loss function comprises at least one of a negative log-likelihood algorithm, a maximum log-likelihood algorithm, or a maximum likelihood algorithm.

Embodiment 21. The non-transitory computer-readable medium of Embodiment 19, wherein the method further comprises identifying a search area using at least one of the selected loss function or another loss function; and computing a local extremum for the selected loss function with respect to the search area.

Embodiment 22. The non-transitory computer-readable medium of Embodiment 21, wherein the method further comprises computing the covariance matrix for the local extremum.

Embodiment 23. The non-transitory computer-readable medium of any one of Embodiments 18 to 22, wherein the method further comprises sampling the plurality of parameters to form a plurality of parameter sets; selecting an initial parameter set from the plurality of parameter sets for the mechanistic model; and computing a covariance matrix for the mechanistic model based on a selected loss function that uses the initial parameter set.

Embodiment 24. The non-transitory computer-readable medium of any one of Embodiments 18 to 23, wherein the method further comprises generating a model prediction distribution for the mechanistic model using the plurality of simulation sets.

Embodiment 25. The non-transitory computer-readable medium of Embodiment 24, wherein the method further comprises identifying a confidence interval for the mechanistic model using the model prediction distribution.

What is claimed is:

1. A method for estimating mechanistic chromatography model uncertainty, the method comprising:
receiving a mechanistic model of chromatography that comprises a plurality of parameters;
identifying, for each of the plurality of parameters, a corresponding region of values based on a relationship between values for the plurality of parameters;
sampling each parameter of the plurality of parameters within the corresponding region of values for each parameter to form a plurality of simulation sets; and
quantifying an uncertainty for the mechanistic model using the plurality of simulation sets.

2. The method of claim 1, wherein identifying, for each of the plurality of parameters, the corresponding region of values comprises:
computing a covariance matrix for the mechanistic model based on a selected loss function.

3. The method of claim 2, wherein the selected loss function comprises at least one of a negative log-likelihood algorithm, a maximum log-likelihood algorithm, or a maximum likelihood algorithm.

4. The method of claim 2, wherein computing the covariance matrix for the mechanistic model based on the selected loss function comprises:
identifying a search area using at least one of the selected loss function or another loss function; and
computing a local extremum for the selected loss function with respect to the search area.

5. The method of claim 4, wherein computing the covariance matrix for the mechanistic model based on the selected loss function further comprises:
computing the covariance matrix for the local extremum.

6. The method of claim 1, wherein identifying, for each of the plurality of parameters, the corresponding region of values comprises:
sampling the plurality of parameters to form a plurality of parameter sets; selecting an initial parameter set from the plurality of parameter sets for the mechanistic model; and
computing a covariance matrix for the mechanistic model based on a selected loss function that uses the initial parameter set.

7. The method of claim 1, wherein quantifying the uncertainty comprises:
generating a model prediction distribution for the mechanistic model using the plurality of simulation sets.

8. The method of claim 7, wherein quantifying the uncertainty further comprises:
identifying a confidence interval for the mechanistic model using the model prediction distribution.

9. The method of claim 1, further comprising:
receiving experiment data; and
generating the mechanistic model using the experiment data.

10. A system for estimating mechanistic chromatography model uncertainty, the system comprising:
a data source configured to obtain a mechanistic model of chromatography; and
a processor configured to receive the mechanistic model of chromatography from the data source in which the mechanistic model includes a plurality of parameters, and wherein the processor is further configured to:
identify, for each of the plurality of parameters, a corresponding region of values based on a relationship between values for the plurality of parameters;
sample each parameter of the plurality of parameters within the corresponding region of values for each parameter to form a plurality of simulation sets; and
quantifying an uncertainty for the mechanistic model using the plurality of simulation sets.

11. The system of claim 10, wherein the processor is further configured to compute a covariance matrix for the mechanistic model based on a selected loss function.

12. The system of claim 11, wherein the selected loss function comprises at least one of a negative log-likelihood algorithm, a maximum log-likelihood algorithm, or a maximum likelihood algorithm.

13. The system of claim 10, wherein the processor is further configured to identify a search area using at least one of the selected loss function or another loss function and compute a local extremum for the selected loss function with respect to the search area.

14. The system of claim 13, wherein the processor is further configured to compute the covariance matrix for the mechanistic model based on the selected loss function by computing the covariance matrix for the local extremum.

15. The system of claim 10, wherein the processor is further configured to sample the plurality of parameters to form a plurality of parameter sets, select an initial parameter set from the plurality of parameter sets for the mechanistic model, and compute a covariance matrix for the mechanistic model based on a selected loss function that uses the initial parameter set.

16. The system of claim 15, wherein the processor is further configured to generate a model prediction distribution for the mechanistic model using the plurality of simulation sets and identify a confidence interval for the mechanistic model using the model prediction distribution.

17. The system of claim 10, wherein the processor is further configured to receive experiment data; and generate the mechanistic model using the experiment data.

18. A non-transitory computer-readable medium in which a program is stored, the program being configured for causing a computer to perform a method for estimating mechanistic chromatography model uncertainty, the method comprising:
receiving a mechanistic model of chromatography that comprises a plurality of parameters;
identifying, for each of the plurality of parameters, a corresponding region of values based on a relationship between values for the plurality of parameters;
sampling each parameter of the plurality of parameters within the corresponding region of values for each parameter to form a plurality of simulation sets; and
quantifying an uncertainty for the mechanistic model using the plurality of simulation sets.

19. The non-transitory computer-readable medium of claim 18, wherein the method further comprises:
computing a covariance matrix for the mechanistic model based on a selected loss function.

20. The non-transitory computer-readable medium of claim 19, wherein the selected loss function comprises at least one of a negative log-likelihood algorithm, a maximum log-likelihood algorithm, or a maximum likelihood algorithm.

21. The non-transitory computer-readable medium of claim 19, wherein the method further comprises:
identifying a search area using at least one of the selected loss function or another loss function; and
computing a local extremum for the selected loss function with respect to the search area.

22. The non-transitory computer-readable medium of claim 21, wherein the method further comprises:
computing the covariance matrix for the local extremum.

23. The non-transitory computer-readable medium of claim 18, wherein the method further comprises:
sampling the plurality of parameters to form a plurality of parameter sets;
selecting an initial parameter set from the plurality of parameter sets for the mechanistic model; and
computing a covariance matrix for the mechanistic model based on a selected loss function that uses the initial parameter set.

24. The non-transitory computer-readable medium of claim 18, wherein the method further comprises:
generating a model prediction distribution for the mechanistic model using the plurality of simulation sets.

25. The non-transitory computer-readable medium of claim 24, wherein the method further comprises:
identifying a confidence interval for the mechanistic model using the model prediction distribution.
